(19) United States
(12) Patent Application Publication
(10) Pub. No.: US 2024/0428730 A1
(43) Pub. Date: Dec. 26, 2024

(54) PIXEL CIRCUIT AND DISPLAY PANEL

(71) Applicant: Wuhan China Star Optoelectronics Semiconductor Display Technology Co., Ltd., Wuhan (CN)

(72) Inventors: Mian ZENG, Wuhan, Hubei (CN); Liang SUN, Wuhan, Hubei (CN)

(73) Assignee: Wuhan China Star Optoelectronics Semiconductor Display Technology Co., Ltd., Wuhan, Hubei (CN)

(21) Appl. No.: 17/623,899

(22) PCT Filed: Dec. 24, 2021
(86) PCT No.: PCT/CN2021/141183

§ 371 Date: Dec. 30, 2021

(30) Foreign Application Priority Data
Dec. 21, 2021 (CN) 202111572332.3

(51) Int. Cl. G09G 3/3233

(52) U.S. Cl. CPC G09G 3/3233; G09G 2300/0819; G09G 2300/0842; G09G 2300/0861; G09G 2320/0247

(57) ABSTRACT

A pixel circuit and a display panel are provided. In the pixel circuit, a first terminal of the driving circuit is connected to a first terminal of the first light-emitting control circuit and a first terminal of the data writing circuit, a second terminal is connected to a source of the first thin film transistor, and a third terminal is connected to a drain of the first thin film transistor and a first terminal of the storage circuit, respectively. The number of thin film transistors directly connected to the driving circuit is reduced so that the current leakage path of the driving circuit is reduced.

### FIELD OF INVENTION

This disclosure relates to a field of display driving technology, and more particularly, to a pixel circuit and display panel.

### BACKGROUND OF INVENTION

With the continuous development of display panel technology, many different types of display panels have appeared. Active-matrix organic light-emitting diode (AMOLED) panels are getting more and more attention. In order to drive AMOLED panels, low temperature poly-silicon thin film transistor (LTPS TFT) driving technology is mainly used at present.

### Technical Problem

Since the leakage current of LTPS TFT is large, a gate potential of a driving TFT in the LTPS TFT driving circuit is unstable within one frame. The output current generated by the driving TFT will also change accordingly, which will eventually cause the brightness of the panel to flicker within one frame.

### SUMMARY OF INVENTION

### Technical Solutions

In one aspect, the technical solutions provided by the disclosure are as follows.

The disclosure provides a pixel circuit, the pixel circuit comprises: a driving circuit, a first light-emitting control circuit, a second light-emitting control circuit, a data writing circuit, a reset circuit, a storage circuit, a first thin film transistor, and a second thin film transistor;
a first terminal of the driving circuit is respectively connected to a first terminal of the first light-emitting control circuit and the first terminal of the data writing circuit, a second terminal of the driving circuit is respectively connected to a source of the first thin film transistor, a drain of the second thin film transistor and a first terminal of the second light-emitting control circuit, and a third terminal of the driving circuit is respectively connected to a drain of the first thin film transistor and a first terminal of the storage circuit;
a second terminal of the first light-emitting control circuit is respectively connected to a second terminal of the storage circuit and a voltage source, a third terminal of the first light-emitting control circuit is connected to receive a light-emitting signal, a second terminal of the second light-emitting control circuit is connected to receive the light-emitting signal, and a third terminal of the second light-emitting control circuit is connected to a first terminal of the reset circuit and is configured to connect to a light-emitting device;
a second terminal of the data writing circuit is connected to a first scan line of a current row, a third terminal of the data writing circuit is connected to a data line, a second terminal of the reset circuit is connected to the first scan line of a current row, and a third terminal of the reset circuit is connected to receive a first initial voltage signal; and
a gate of the first thin film transistor is connected to a second scan line of a current row, a gate of the second thin film transistor is connected to the first scan line of a previous row, and a source of the second thin film transistor is connected to receive a second initial voltage signal.

In another aspect, the embodiment of the disclosure further provides a display panel. The display panel comprises a light-emitting layer and a driving layer, wherein the driving layer is configured to drive the light-emitting layer to emit light. The driving layer comprises a pixel circuit.

The pixel circuit comprises: a driving circuit, a first light-emitting control circuit, a second light-emitting control circuit, a data writing circuit, a reset circuit, a storage circuit, a first thin film transistor, and a second thin film transistor;

a first terminal of the driving circuit is respectively connected to a first terminal of the first light-emitting control circuit and the first terminal of the data writing circuit, a second terminal of the driving circuit is respectively connected to a source of the first thin film transistor, a drain of the second thin film transistor and a first terminal of the second light-emitting control circuit, and a third terminal of the driving circuit is respectively connected to a drain of the first thin film transistor and a first terminal of the storage circuit;
a second terminal of the first light-emitting control circuit is respectively connected to a second terminal of the storage circuit and a voltage source, a third terminal of the first light-emitting control circuit is connected to receive a light-emitting signal, a second terminal of the second light-emitting control circuit is connected to receive the light-emitting signal, and a third terminal of the second light-emitting control circuit is connected to a first terminal of the reset circuit and is configured to connect to a light-emitting device;
a second terminal of the data writing circuit is connected to a first scan line of a current row, a third terminal of the data writing circuit is connected to a data line, a second terminal of the reset circuit is connected to the first scan line of a current row, and a third terminal of the reset circuit is connected to receive a first initial voltage signal; and
a gate of the first thin film transistor is connected to a second scan line of a current row, a gate of the second thin film transistor is connected to the first scan line of a previous row, and a source of the second thin film transistor is connected to receive a second initial voltage signal.

### Beneficial Effects

The disclosure provides a pixel circuit and a display panel. The pixel circuit includes a driving circuit, a first light-emitting control circuit, a second light-emitting control circuit, a data writing circuit, a reset circuit, a storage circuit, a first thin film transistor, and a second thin film transistor. A drain of the first thin film transistor is directly connected to the driving circuit. A drain of the second thin film transistor is indirectly connected to the driving circuit with the first thin film transistor. The number of thin film transistors directly connected to the driving circuit is reduced, and the current leakage path of the driving circuit is reduced, so that the current output by the driving circuit in the light-emitting stage is more stable, and the problem of image brightness flickering is solved.

### DESCRIPTION OF DRAWINGS

In order to more clearly illustrate the embodiments of the disclosure or the technical solutions in the prior art, the following briefly introduces the accompanying drawings used in the embodiments. Obviously, the drawings in the following description merely show some of the embodiments of the disclosure. As regards one of ordinary skill in the art, other drawings can be obtained in accordance with these accompanying drawings without making creative efforts.

FIG. 1 is a schematic diagram of a structure of a pixel circuit according to an embodiment of the disclosure.

FIG. 2 is a schematic diagram of another structure of the pixel circuit according to an embodiment of the disclosure.

FIG. 3 is a first circuit diagram of the pixel circuit according to the embodiment of the disclosure.

FIG. 4 is a second circuit diagram of the pixel circuit according to the embodiment of the disclosure.

FIG. 5 is a third circuit diagram of the pixel circuit according to the embodiment of the disclosure.

FIG. 6 is a fourth circuit diagram of the pixel circuit according to the embodiment of the disclosure.

FIG. 7 is a fifth circuit diagram of the pixel circuit according to the embodiment of the disclosure.

FIG. 8 is a sixth circuit diagram of the pixel circuit according to the embodiment of the disclosure.

FIG. 9 is a timing diagram of the driving signal corresponding to the display scan of the pixel circuit according to the embodiment of the disclosure.

FIG. 10 is a schematic diagram of the timing of the GOA driving signal corresponding to the pixel circuit according to the embodiment of the disclosure.

FIG. 11 is a schematic diagram of the pixel circuit corresponding to the driving timing of a display panel according to the embodiment of the disclosure (take 60 Hz as an example).

FIG. 12 is a schematic diagram of the brightness measurement effect of the pixel circuit according to the embodiment of the disclosure.

### DETAILED DESCRIPTION OF PREFERRED EMBODIMENTS

In order to facilitate the understanding of the application, the application will be described in a more comprehensive manner with reference to the drawings. The preferred embodiments of the disclosure are shown in the accompanying drawings. However, these embodiments can be implemented in many different forms and are not limited to the embodiments described herein. On the contrary, the object of providing these embodiments is to make the disclosure of this application more thorough and comprehensive.

It should be noted that when an element is considered to “connect” another element, it can be directly connected to and integrated with another element, or there may be intermediate elements at the same time. The terms “install”, “one terminal”, “other terminal” and similar expressions used herein are for illustrative purposes only.

Unless otherwise defined, all technical and scientific terms used herein have the same meanings as those commonly understood by those skilled in the technical field of the application. The terms used in the specification of the present application herein are only for the purpose of describing specific embodiments and are not intended to limit the present application. The term “and/or” as used herein includes any and all combinations of one or more related listed items.

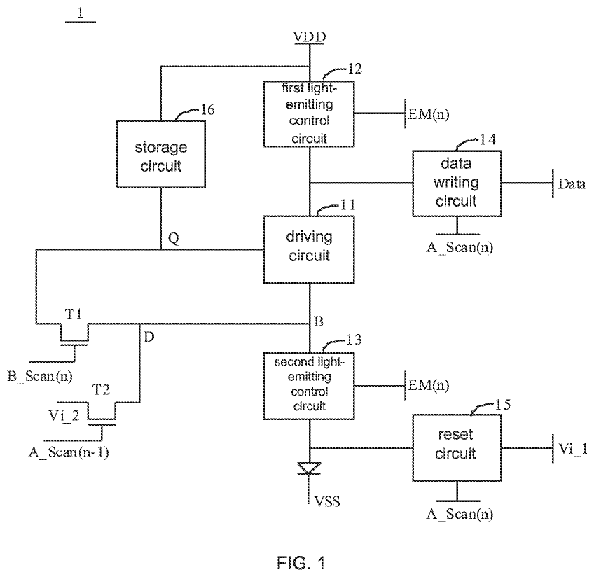

In order to solve the technical problem of the brightness flicker of the conventional AMOLED panel, an embodiment of the present application provides a pixel circuit 1. As shown in FIG. 1, the pixel circuit 1 of the disclosure includes a driving circuit 11, a first light-emitting control circuit 12, a second light-emitting control circuit 13, a data writing circuit 14, a reset circuit 15, a storage circuit 16, a first thin film transistor T1 and a second thin film transistor T2.

The driving circuit 11 is configured for driving a light-emitting device to emit light according to a data voltage signal (the data voltage signal transmitted by a data line is written into the driving circuit 11 by the data writing circuit 14). In the pixel circuit 1 of the disclosure, a first terminal of the driving circuit 11 is connected to a first terminal of the first light-emitting control circuit 12 and a first terminal of the data writing circuit 14, respectively. A second terminal of the driving circuit 11 is connected to a source of the first thin film transistor T1, a drain of the second thin film transistor T2 and a first terminal of the second light-emitting control circuit 13, respectively. A third terminal of the drive circuit 11 is connected to a drain of the first thin film transistor T1 and a first terminal of the storage circuit 16, respectively.

The first light-emitting control circuit 12 and the second light-emitting control circuit 13 are used to control the storage circuit 16 to couple a data voltage to the driving circuit 11 during a light-emitting stage of the pixel circuit 1 of the disclosure, so that the driving circuit 11 generates a driving current according to the data signal to drive the light-emitting device to emit light. In the pixel circuit 1 of the disclosure,

The first terminal of the first light-emitting control circuit 12 is connected to the first terminal of the drive circuit 11. The second terminal of the first light-emitting control circuit 12 is respectively connected to the second terminal of the storage circuit 16 and a voltage source (VDD shown in FIG. 1). The third terminal of the first light-emitting control circuit 12 is connected to receive an emitting (EM) signal (EM (n) in FIG. 1). A first terminal of the second light-emitting control circuit 13 is connected to the second terminal of the driving circuit 11. A second terminal of the second light-emitting control circuit 13 is connected to receive a light-emitting signal. A third terminal of the second light-emitting control circuit 13 is connected to a first terminal of the reset circuit 15 and is used to connect the light-emitting device.

The data writing circuit 14 is used to connect to the data line to receive the data voltage signal transmitted by the data line, and to write the data voltage signal into the driving circuit 11. In the pixel circuit 1 of the disclosure, a first terminal of the data writing circuit 14 is connected to the first terminal of the driving circuit 11. A second terminal of the data writing circuit 14 is connected to a first scan line of a current row (A_Scan(n) in FIG. 1). It should be noted that the first scan line is used to transmit high-frequency scan signals. A third terminal of the data writing circuit 14 is connected to the data line (Data in FIG. 1).

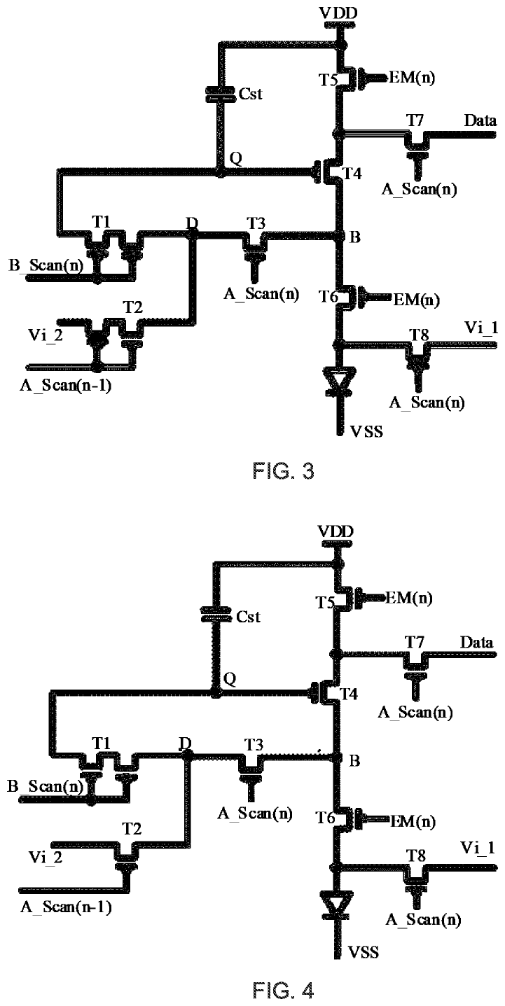

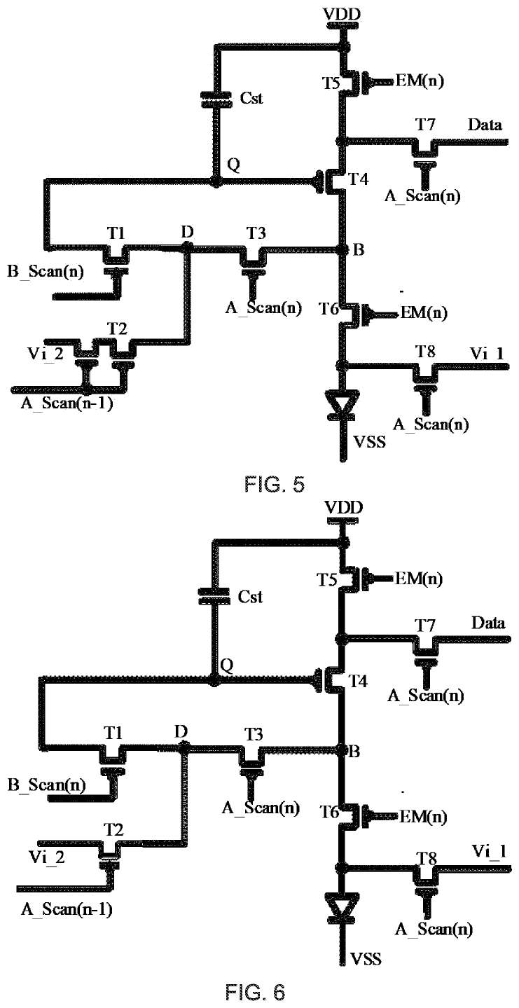

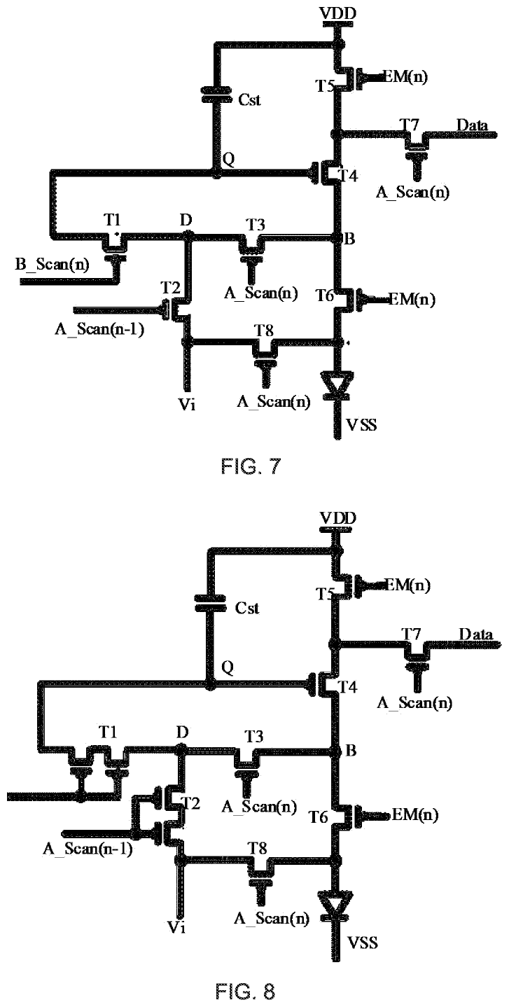

The reset circuit 15 is used to reset the potential of the light-emitting device. In the pixel circuit 1 of the disclosure, referring to FIG. 3 to FIG. 6, a first terminal of the reset circuit 15 is connected to the third terminal of the second light-emitting control circuit 13. A second terminal of the reset circuit 15 is connected to the first scan line of a current row. A third terminal of the reset circuit 15 is connected to receive a first initial voltage signal (Vi_1 in FIG. 1). In this embodiment, the reset circuit 15 and the second thin film transistor T2 respectively receive the first initial voltage signal and a second initial voltage signal (Vi_2 in FIG. 1). In another embodiment, referring to FIG. 7 and FIG. 8, the third terminal of the reset circuit 15 is connected to the source of the second thin film transistor T2. The first initial voltage signal and the second initial voltage signal are same signal. In this embodiment, the reset circuit 15 and the second thin film transistor T2 share an initial voltage signal.

The first thin film transistor T1 and the second thin film transistor T2 are configured to reset the driving circuit 11 (specifically, reset the potential at point Q as shown in FIGS. 1-8). In the pixel circuit 1 of the disclosure, the source of the first thin film transistor T1 is connected to the second terminal of the driving circuit 11. The drain of the first thin film transistor T1 is connected to the third terminal of the driving circuit 11. The gate of the first thin film transistor T1 is connected to a second scan line of a current row (B_Scan(n) in FIG. 1). It should be noted that the second scan line is used to transmit low-frequency scan signals. The drain of the second thin film transistor T2 is connected to the second terminal of the driving circuit 11. The gate of the second thin film transistor T2 is connected to the first scan line of a previous row (A_Scan(n−1) in FIG. 1). The source of the second thin film transistor T2 receives the second initial voltage signal. The connection mode of the first thin film transistor T1 and the second thin film transistor T2 with the drive circuit 11 provided in the disclosure reduces the number of thin film transistors connected to the point Q of the drive circuit 11, thereby reducing the leakage current of the point Q of the drive circuit 11 and preventing the screen brightness flicker within one frame of a display panel.

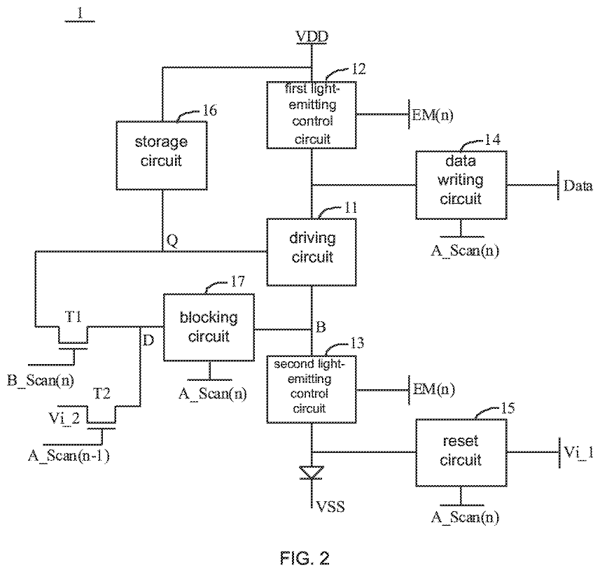

In order to reduce the influence of the potential of point B on the potential of point Q as shown in FIGS. 1-8 in the light-emitting stage, as shown in FIG. 2, the pixel circuit 1 of the disclosure further includes a blocking circuit 17. Specifically, a first terminal of the blocking circuit 17 is connected to the second terminal of the driving circuit 11 and the first terminal of the second light-emitting control circuit 13, respectively. A second terminal of the blocking circuit 17 is connected to the source of the first thin film transistor T1 and the drain of the second thin film transistor T2, respectively, and a third terminal of the blocking circuit 17 is connected to the first scan line of a current row. The blocking circuit 17 can prevent the influence of the potential at the point B on the potential at the point Q, thereby preventing the screen brightness flicker within one frame of the display panel.

The driving circuit 11, the first light-emitting control circuit 12, the second light-emitting control circuit 13, the data writing circuit 14, the reset circuit 15 and the storage circuit 16 can be set to different circuits according to the actual requirements.

In one embodiment, referring to FIG. 3 to FIG. 8, the blocking circuit 17 includes a third thin film transistor T3. A source of the third thin film transistor T3 is respectively connected to the second terminal of the driving circuit 11 and the first terminal of the second light-emitting control circuit 13. A drain of the third thin film transistor T3 is connected to the source of the first thin film transistor T1 and the drain of the second thin film transistor T2, respectively. A gate of the third thin film transistor T3 is connected to the first scan line of a current row.

The driving circuit 11 includes a fourth thin film transistor T4. A source of the fourth thin film transistor T4 is respectively connected to the first terminal of the first light-emitting control circuit 12 and the first terminal of the data writing circuit 14. A drain of the fourth thin film transistor T4 is respectively connected to the source of the first thin film transistor T1, the drain of the second thin film transistor T2 and the first terminal of the second light-emitting control circuit 13. A gate of the fourth thin film transistor T4 is respectively connected to the drain of the first thin film transistor T1 and the first terminal of the storage circuit 14.

The first light-emitting control circuit 12 includes a fifth thin film transistor T5. A source of the fifth thin film transistor T5 is respectively connected to the second terminal of the storage circuit 16 and the voltage source. A drain of the fifth thin film transistor T5 is connected to the source of the fourth thin film transistor T4, and a gate of the fifth thin film transistor T5 is connected to receive the light-emitting signal.

The second light-emitting control circuit 13 includes a sixth thin film transistor T6. A source of the sixth thin film transistor T6 is respectively connected to the source of the first thin film transistor T1, the drain of the second thin film transistor T2 and the drain of the fourth thin film transistor T4. A gate of the sixth thin film transistor T6 receives the light-emitting signal, and a drain of the sixth thin film transistor T6 is connected to the first terminal of the reset circuit 15 and is configured to connect to the light-emitting device.

The data writing circuit 14 includes a seventh thin film transistor T7. A drain of the seventh thin film transistor T7 is connected to the source of the fourth thin film transistor T4 and the drain of the fifth thin film transistor T5, respectively. A gate of the seventh thin film transistor T7 is connected to the first scan line of a current row, and a source of the seventh thin film transistor T7 is connected to the data line.

The reset circuit 15 includes an eighth thin film transistor T8. A drain of the eighth thin film transistor T8 is connected to the drain of the sixth thin film transistor T6, respectively. A gate of the eighth thin film transistor T8 is connected to the first scan line of a current row, and a source of the eighth thin film transistor T8 receives the first initial voltage signal.

The storage circuit 16 includes a capacitor Cst. A first terminal of the capacitor Cst is connected to the gate of the fourth thin film transistor T4, and a second terminal of the capacitor Cst is connected to the source of the fifth thin film transistor T5.

The type of the first thin film transistor T1 can be selected according to actual requirements, and the first thin film transistor T1 is a single gate thin film transistor or a double gate thin film transistor. The type of the second thin film transistor T2 can be selected according to actual requirements. The second thin film transistor T2 is a single gate thin film transistor or a double gate thin film transistor. The following four examples can be combined: example 1: the first thin film transistor T1 is a single gate thin film transistor, and the second thin film transistor T2 is a single gate thin film transistor; example 2: the first thin film transistor T1 is a double gate thin film transistor, and the second thin film transistor T2 is a single gate thin film transistor; example 3: the first thin film transistor T1 is a single gate thin film transistor, and the second thin film transistor T2 is a double gate thin film transistor; and example 4: the first thin film transistor T1 is a double gate thin film transistor, and the second thin film transistor T2 is a double gate thin film transistor. It should be noted that the effect of preventing current leakage of double gate thin film transistor is better than that of single gate thin film transistor.

In order to understand the working principle of the pixel circuit 1 of the disclosure, an exemplary embodiment is described below.

The pixel circuit 1 of the disclosure includes a driving circuit 11, a first light-emitting control circuit 12, a second light-emitting control circuit 13, a data writing circuit 14, a reset circuit 15, a storage circuit 16, a first thin film transistor T1 and a second thin film transistor T2.

The first thin film transistor T1 is a double gate thin film transistor, the second thin film transistor T2 is a double gate thin film transistor. The blocking circuit 17 includes a third thin film transistor T3, and the driving circuit 11 includes a fourth thin film transistor T4. The first light-emitting control circuit 12 includes a fifth thin film transistor T5, and the second light-emitting control circuit 13 includes a sixth thin film transistor T6. The data writing circuit 14 includes a seventh thin film transistor T7, the reset circuit 15 includes an eighth thin film transistor T8, and the storage circuit 16 includes a capacitor Cst.

The source of the first thin film transistor T1 is connected to the drain of the second thin film transistor T2 and the drain of the third thin film transistor T3, respectively. The drain of the first thin film transistor T1 is connected to the gate of the fourth thin film transistor T4 and one terminal of the capacitor Cst, respectively. The gate of the first thin film transistor T1 is connected to the second scan line of a current row.

The drain of the second thin film transistor T2 is respectively connected to the source of the first thin film transistor T1 and the drain of the third thin film transistor T3. The gate of the second thin film transistor T2 is connected to the first scan line of a previous row, and the source of the second thin film transistor T2 is connected to the second initial voltage signal.

The drain of the third thin film transistor T3 is connected to the source of the first thin film transistor T1 and the drain of the second thin film transistor T2, respectively. The source of the third thin film transistor T3 is connected to the drain of the fourth thin film transistor T4 and the source of the sixth thin film transistor T6, respectively, and the gate of the third thin film transistor T3 is connected to the first scan line of a current row.

The gate of the fourth thin film transistor T4 is connected to the drain of the first thin film transistor T1 and one terminal of the capacitor Cst, respectively. The source of the fourth thin film transistor T4 is connected to the drain of the fifth thin film transistor T5 and the drain of the seventh thin film transistor T7, respectively. The drain of the fourth thin film transistor T4 is connected to the source of the third thin film transistor T3 and the source of the sixth thin film transistor T6, respectively.

The drain of the fifth thin film transistor T5 is connected to the source of the fourth thin film transistor T4 and the drain of the seventh thin film transistor T7, respectively. The source of the fifth thin film transistor T5 is respectively connected to the other terminal of the capacitor Cst, and the gate of the fifth thin film transistor T5 receives the light-emitting signal.

The source of the sixth thin film transistor T6 is connected to the source of the third thin film transistor T3 and the drain of the fourth thin film transistor T4, respectively. The drain of the sixth thin film transistor T6 is connected to the drain of the eighth thin film transistor T8 and the light emitting device, respectively, and the gate of the sixth thin film transistor T6 receives the light-emitting signal.

The drain of the seventh thin film transistor T7 is connected to the source of the fourth thin film transistor T4 and the drain of the fifth thin film transistor T5, respectively. The source of the seventh thin film transistor T7 is connected to the data line, and the gate of the seventh thin film transistor T7 is connected to the first scan line of a current row.

The drain of the eighth thin film transistor T8 is connected to the drain of the sixth thin film transistor T6 and the light-emitting device, respectively. The source of the eighth thin film transistor T8 receives the first initial voltage signal, and the gate of the eighth thin film transistor T8 is connected to the first scan line of the current row.

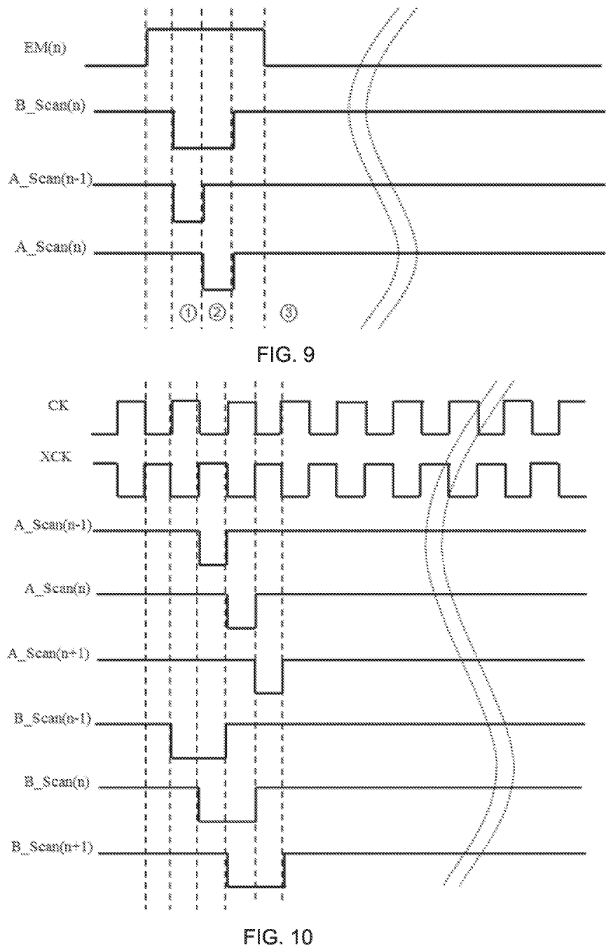

It should be noted that, as shown in FIG. 9 a timing diagram of the driving signal corresponding to the display scan of the pixel circuit 1 according to the embodiment of the disclosure is shown. The operation of the pixel circuit 1 is mainly divided into three stages:

In a first stage (the stage of resetting the potential of the Q point), the signals transmitted by the first scan line of the previous row and the second scan line of the current row are both low level, and the signals transmitted by the first scan line of the current row and the light-emitting signal are both high level. The first thin film transistor T1 and the second thin film transistor T2 are both turned on at the same time, the third thin film transistor T3, the fifth thin film transistor T5, the sixth thin film transistor T6, the seventh thin film transistor T7 and the eighth thin film transistor T8 are turned off, and the gate of the fourth thin film transistor T4 is reset to the second initial voltage signal.

In a second stage (the stage of charging and resetting the anode of the light-emitting device), the light-emitting signal is still at a high level, and the fifth thin film transistor T5 and the sixth thin film transistor T6 are turned off. The signals transmitted by the first scan line of the current row and the second scan line of the current row are both low level. The first thin film transistor T1 and the seventh thin film transistor T7 are turned on at the same time. The data signal transmitted by the data line is written to point Q through the first thin film transistor T1 and the seventh thin film transistor T7, and the starting voltage (Vth) of the fourth thin film transistor T4 is captured reversely. The eighth thin film transistor T8 is turned on to reset the anode of the light-emitting device to the first initial voltage signal.

In a third stage (the stage of light-emitting), the signals transmitted by the first scan line of the current row and the second scan line of the current row are both high level, and the light-emitting signals are at low potential. The fifth thin film transistor T5 and the sixth thin film transistor T6 are turned on, and the fourth thin film transistor T4 generates a current corresponding to the data signal through the point Q potential, and drives the light emitting device to emit light.

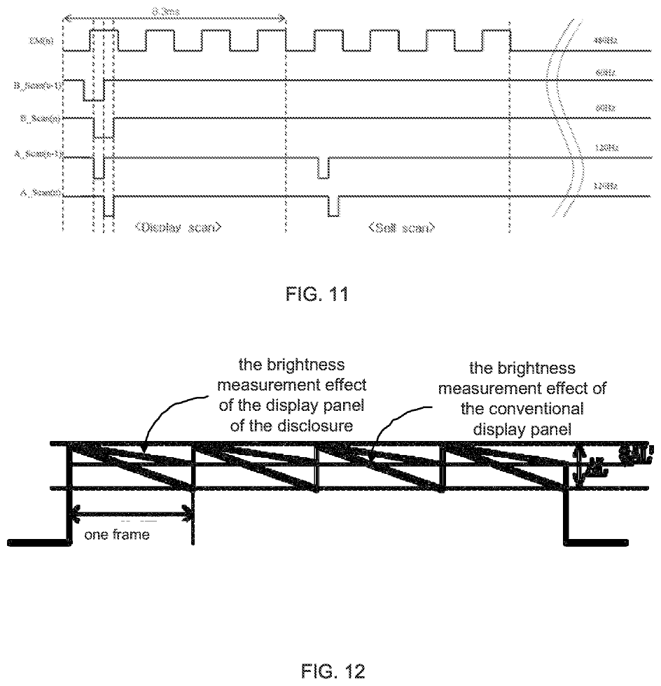

In FIG. 10, a schematic diagram of the timing of the GOA (Gate on Array) driving signal corresponding to the pixel circuit 1 of the disclosure is shown. The first scan line of the current row and the second scan line of the current row can be generated by two sets of GOA circuits or one set of GOA circuits. When driving at low frequency, as shown in FIG. 11, the second scan line of the current row is set to the low frequency scan correspondingly, and the first scan line of the current row still maintains the high frequency scan. The data signal transmitted by the data line is designed as a high potential signal of VGMP (VGMP is the highest voltage of Gamma (gamma voltage), corresponding to the highest gray-scale voltage) in a blank interval. The drain of the fourth thin film transistor T4 can receive the Bias signal of the VGMP at a high frequency, so as to reduce the start-up voltage deviation of the fourth thin film transistor T4 under long-term pressure at low frequency, which causes the display quality degradation. The second scan line is written corresponding to the data signal during low-frequency driving, and its frequency is consistent with a refresh frequency of the data signal. The first scan line is used for resetting, so as to prevent the first thin film transistor T1 from being subjected to long-term stress during low-frequency driving in the conventional design.

Compared with the conventional pixel circuit, the pixel circuit 1 of the disclosure reduces the current leakage path of the point Q, and increases the number of thin film transistors between the point B and the point D as shown in FIGS. 1 to 8. That reduces the influence of the potential of the point B on the potential of the point Q in the light-emitting stage, and can minimize the current leakage of point Q. In addition, in this disclosure, the amount of potential change at point Q within one frame is reduced, and the start-up voltage deviation of the fourth thin film transistor T4 under long-time pressure at low frequency can be reduced. Thus, the change of the brightness of the light-emitting device in one frame during low-frequency driving is reduced, so as to reduce the flicker during low-frequency driving and improve the display quality during low-frequency driving.

The pixel circuit 1 of the disclosure is applied to a display panel. The disclosure further provides a display panel, the display panel comprises a light emitting layer and a driving layer. The driving layer is configured to drive the light-emitting layer to emit light. The driving layer is provided with a pixel circuit 1 as described above.

Referring to FIG. 12, the luminous stability of the display panel of the disclosure (ΔL′ in FIG. 12) is significantly improved compared to the luminous stability of the conventional display panel (ΔL in FIG. 12). It should be noted that the pixel circuit 1 of this embodiment is the same as that described in the previous embodiments of the pixel circuit 1 of this disclosure, and will not be repeated herein.

The technical features of the above-mentioned embodiments can be combined arbitrarily. In order to make the description concise, all possible combinations of the various technical features in the above-mentioned embodiments are not described. However, as long as there is no contradiction in the combination of these technical features, it shall be considered to be disclosed within the scope of the specification.

The above embodiments only describe several embodiments of the disclosure, and the description is more specific and detailed, but it cannot be understood as a limitation on the scope of the disclosure. It should be noted that for those skilled in the art, without departing from the concept of this disclosure, several modifications and improvements can be made, which belong to the protection scope of the disclosure. Therefore, the scope of the disclosure shall be subject to the appended claims.

What is claimed is:

1. A pixel circuit, comprising: a driving circuit, a first light-emitting control circuit, a second light-emitting control circuit, a data writing circuit, a reset circuit, a storage circuit, a first thin film transistor, and a second thin film transistor;
wherein a first terminal of the driving circuit is respectively connected to a first terminal of the first light-emitting control circuit and the first terminal of the data writing circuit, a second terminal of the driving circuit is respectively connected to a source of the first thin film transistor, a drain of the second thin film transistor and a first terminal of the second light-emitting control circuit, and a third terminal of the driving circuit is respectively connected to a drain of the first thin film transistor and a first terminal of the storage circuit;
wherein a second terminal of the first light-emitting control circuit is respectively connected to a second terminal of the storage circuit and a voltage source, a third terminal of the first light-emitting control circuit is connected to receive a light-emitting signal, a second terminal of the second light-emitting control circuit is connected to receive the light-emitting signal, and a third terminal of the second light-emitting control circuit is connected to a first terminal of the reset circuit and is configured to connect to a light-emitting device;
wherein a second terminal of the data writing circuit is connected to a first scan line of a current row, a third terminal of the data writing circuit is connected to a data line, a second terminal of the reset circuit is connected to the first scan line of a current row, and a third terminal of the reset circuit is connected to receive a first initial voltage signal; and
wherein a gate of the first thin film transistor is connected to a second scan line of a current row, a gate of the second thin film transistor is connected to the first scan line of a previous row, and a source of the second thin film transistor is connected to receive a second initial voltage signal.

2. The pixel circuit according to claim 1, wherein the pixel circuit further comprises a blocking circuit;
wherein a first terminal of the blocking circuit is respectively connected to the second terminal of the driving circuit and the first terminal of the second light-emitting control circuit, a second terminal of the blocking circuit is respectively connected to the source of the first thin film transistor and the drain of the second thin film transistor, and a third terminal of the blocking circuit is connected to the first scan line of a current row.

3. The pixel circuit according to claim 2, wherein the blocking circuit comprises a third thin film transistor;
wherein a source of the third thin film transistor is respectively connected to the second terminal of the driving circuit and the first terminal of the second light-emitting control circuit, a drain of the third thin film transistor is respectively connected to the source of the first thin film transistor and the drain of the second thin film transistor, and a gate the third thin film transistor is connected to the first scan line of a current row.

4. The pixel circuit according to claim 1, wherein the first thin film transistor is a single gate thin film transistor or a double gate thin film transistor, and the second thin film transistor is a single gate thin film transistor or a double gate thin film transistor.

5. The pixel circuit according to claim 1, wherein a third terminal of the reset circuit is connected to the source of the second thin film transistor, and the first initial voltage signal and the second initial voltage signal are same signal.

6. The pixel circuit according to claim 1, wherein the driving circuit includes a fourth thin film transistor;
wherein a source of the fourth thin film transistor is respectively connected to the first terminal of the first light-emitting control circuit and the first terminal of the data writing circuit, a drain of the fourth thin film transistor is respectively connected to the source of the first thin film transistor, the drain of the second thin film transistor and the first terminal of the second light-emitting control circuit, and a gate of the fourth thin film transistor is respectively connected to the drain of the first thin film transistor and the first terminal of the storage circuit.

7. The pixel circuit according to claim 6, wherein the first light-emitting control circuit includes a fifth thin film transistor;
wherein a source of the fifth thin film transistor is respectively connected to the second terminal of the storage circuit and the voltage source, a drain of the fifth thin film transistor is connected to the source of the fourth thin film transistor, and a gate of the fifth thin film transistor is connected to receive the light-emitting signal.

8. The pixel circuit according to claim 7, wherein the second light-emitting control circuit includes a sixth thin film transistor;
wherein a source of the sixth thin film transistor is respectively connected to the source of the first thin film transistor, the drain of the second thin film transistor and the drain of the fourth thin film transistor, a gate of the sixth thin film transistor is connected to receive the light-emitting signal, and a drain of the sixth thin film transistor is connected to the first terminal of the reset circuit and is configured to connect to the light-emitting device.

9. The pixel circuit according to claim 8, wherein the data writing circuit includes a seventh thin film transistor;
wherein a drain of the seventh thin film transistor is respectively connected to the source of the fourth thin film transistor and the drain of the fifth thin film transistor, a gate of the seventh thin film transistor is connected to the first scan line of a current row, and a source of the seventh thin film transistor is connected to the data line.

10. The pixel circuit according to claim 9, wherein the reset circuit includes an eighth thin film transistor;
wherein a drain of the eighth thin film transistor is respectively connected to the drain of the sixth thin film transistor, a gate of the eighth thin film transistor is connected to the first scan line of a current row, and a source of the eighth thin film transistor is connected to receive the first initial voltage signal.

11. The pixel circuit according to claim 10, wherein the storage circuit includes a capacitor;
wherein a first terminal of the capacitor is connected to the gate of the fourth thin film transistor, and a second terminal of the capacitor is connected to the source of the fifth thin film transistor.

12. A display panel, comprising a light-emitting layer and a driving layer, wherein the driving layer is configured to drive the light-emitting layer to emit light;
wherein the driving layer comprises a pixel circuit;
wherein the pixel circuit comprises a driving circuit, a first light-emitting control circuit, a second light-emitting control circuit, a data writing circuit, a reset circuit, a storage circuit, a first thin film transistor, and a second thin film transistor;
wherein a first terminal of the driving circuit is respectively connected to a first terminal of the first light-emitting control circuit and the first terminal of the data writing circuit, a second terminal of the driving circuit is respectively connected to a source of the first thin film transistor, a drain of the second thin film transistor and a first terminal of the second light-emitting control circuit, and a third terminal of the driving circuit is respectively connected to a drain of the first thin film transistor and a first terminal of the storage circuit;
wherein a second terminal of the first light-emitting control circuit is respectively connected to a second terminal of the storage circuit and a voltage source, a third terminal of the first light-emitting control circuit is connected to receive a light-emitting signal, a second terminal of the second light-emitting control circuit is connected to receive the light-emitting signal, and a third terminal of the second light-emitting control circuit is connected to a first terminal of the reset circuit and is configured to connect to a light-emitting device;
wherein a second terminal of the data writing circuit is connected to a first scan line of a current row, a third terminal of the data writing circuit is connected to a data line, a second terminal of the reset circuit is connected to the first scan line of a current row, and a third terminal of the reset circuit is connected to receive a first initial voltage signal; and
wherein a gate of the first thin film transistor is connected to a second scan line of a current row, a gate of the second thin film transistor is connected to the first scan line of a previous row, and a source of the second thin film transistor is connected to receive a second initial voltage signal.
